(19) United States
(12) Patent Application Publication
(10) Pub. No.: US 2026/0138566 A1
(43) Pub. Date: May 21, 2026

(54) ADAPTER ASSEMBLY FOR A VEHICLE WIPER SYSTEM

(71) Applicant: VALEO SYSTEMES D'ESSUYAGE, La Verriere (FR)

(72) Inventors: Thomas CAETANO, La Verriere (FR); Stephane HOUSSAT, La Verrière (FR); Vincent GAUCHER, La Verrière (FR)

(73) Assignee: VALEO SYSTEMES D'ESSUYAGE, La Verriere (FR)

(21) Appl. No.: 18/953,381

(22) Filed: Nov. 20, 2024

(51) Int. Cl. B60S 1/40; B60S 1/38

(52) U.S. Cl. CPC B60S 1/4003; B60S 1/387; B60S 1/4067

(57) ABSTRACT

The present invention relates to an adapter assembly for a vehicle wiper system. The adapter assembly includes a spacer member releasably mounted on a base member. The spacer member includes flanks spaced apart from each other and connected to each other by an upper wall. The spacer member further includes two longitudinal lugs adapted to be received in corresponding slots of a yoke of a wiper arm. The spacer member includes a flexible cantilever having a button, and a bearing tab provided below the button such that a push-button of the base member may be locked to the bearing tab. The button of the spacer member may be received in a cut-out of the yoke and may facilitate the unlocking of the push-button. The spacer member makes the adapter assembly compatible with the wiper arm having the yoke design including side walls and a top wall having the cut-out.

### TECHNICAL FIELD

The present invention relates to a windscreen wiper system for a motor vehicle, and more particularly to an adapter assembly for connecting a windscreen wiper blade to an arm of a wiper system.

### BACKGROUND OF THE INVENTION

The wiper system traditionally consists of a wiper arm, one end of which is connected to an output shaft of a wiper motor through linkages and a wiper blade is attached to another end of the wiper arm. The wiper motor drives the wiper arm to swing between the predefined angular positions to wipe out the water and dirt present on the windshield.

Each wiper blade comprises a structure supporting a wiper rubber intended to be placed in contact with the windscreen so that it can remove water and/or dirt from the windscreen panel. Additionally, each wiper blade comprises a connector rigidly connected to the structure of the wiper blade and an adapter assembly is mounted pivotally on the connector in order to allow the detachable fastening of the wiper arm of the wiper system to the adapter assembly.

In a known manner, a yoke/clevis is formed at the end of the wiper arm and the yoke/clevis is engaged with the adapter assembly and locked therein. There are variety of wiper arms having different designs of the yoke, being used in different motor vehicles. This requires motor vehicle manufacturers to design adapter assembly specific to each type of wiper arm, an adapter assembly specifically making the link between a type of wiper arm and a connector. So, the equipment manufacturers needs to develop many different adapters, including at least one for each type of wiper arm on the market. Further, the users who need to change their wiper blade, needs to adapt and take extra care to choose the right adapter assembly for the type of wiper arm on which the wiper blade is to be mounted. This creates lot of inconvenience to the user while changing the wiper blades. Moreover, the part count of the adapter assembly may increase in order to make it compatible with different types of wiper arms. This may increase the material, weight, and/or cost associated with the adapter assembly

The prior art and the conventional adapter assembly have various disadvantages as described above and there is a need for an adapter assembly for vehicle wiper system, that can overcome the disadvantages of the conventional wiper system.

### SUMMARY OF THE INVENTION

An object of the present invention is to solve the disadvantages described above of known adapter assembly. In particular, an object of the present invention is to provide an adapter assembly compatible with multiple wiper arms having different yoke designs.

Another object of the present invention is to provide a spacer member for an adapter assembly to make the adapter assembly compatible with a wiper arm having yoke with pins on inner surface of side walls and a cut-out in a top wall.

Yet another object of the present invention is to provide an adapter assembly for connecting a wiper arm having pins and cut-out in the yoke to the wiper blade.

In this context, the present invention is directed towards a spacer member for an adapter assembly of a wiper system. The spacer member may include a front end and a rear end longitudinally opposite to the front end. The spacer member may further include two flanks extending longitudinally between the front end and the rear end. The flanks may be spaced apart from each other and connected to each other by an upper wall. The upper wall may extend longitudinally rearwards from an upper bridge. Preferably, the upper bridge and the upper wall may be integrally formed with the flanks. The spacer member may further include two longitudinal lugs distributed laterally on either sides of a central longitudinal axis of the spacer member. Each of the two longitudinal lugs may be extended by side arms emerging from the upper bridge. Preferably the side arms may be integrally formed with the upper bridge. The longitudinal lugs may be adapted to be received in corresponding slots provided on side walls of a yoke of a wiper arm. The longitudinal lugs may guide the spacer member while mounting the spacer member to the yoke. The longitudinal lugs may further restrict relative vertical movement between the spacer member and the yoke, once the spacer member is secured to the yoke. A flexible cantilever may be provided extending towards the rear end from the upper wall. The flexible cantilever may include a button formed at an end opposite to the upper wall. The button may be vertically offset from the upper wall. When the spacer member is secured to the yoke, the button of the flexible cantilever may be received in a corresponding cut-out formed in a top wall of the yoke. The button may ensure proper positioning of the spacer member relative to the yoke. In some cases, the button may also lock the spacer member to the yoke. Advantageously, the button may also facilitate detachment of the spacer member from a base member of the adapter assembly. Moreover, a bearing tab may be provided connecting the flanks. The bearing tab may have an upper surface vertically offset from the upper wall. The bearing tab may be positioned substantially below the button. Preferably, the bearing tab may be integrally formed with the flanks and may extend vertically upwards from upper edges of the flanks. The bearing tab may be adapted to cooperate with a push-button of the base member to releasably secure the base member to the spacer member.

In a non-limiting embodiment of the present invention, the flexible cantilever may further include at least one indentation formed on lower side of the button, the indentation being configured to cooperate with the bearing tab. The indentation may have a shape complementing the shape of the upper surface of the bearing tab. The indentation may allow proper positioning of the push-button of the base member vertically between the button of the spacer member and the bearing tab of the spacer member.

In a non-limiting embodiment of the present invention, at least one of the longitudinal lugs may include a deformable finger projecting from at least one of an upper edge and a lower edge of the longitudinal lug. Preferably, both the longitudinal lugs may include the deformable finger. Further, the deformable finger may be formed on either of the upper edge and lower edge of the longitudinal lug or on both the upper and lower edges of the longitudinal lug. The deformable finger may be adapted to cooperate with internal edge of the slot of the yoke to releasably secure the spacer member with the yoke. More specifically, the deformable finger may limit the vertical play between the spacer member and the yoke.

In a non-limiting embodiment of the present invention, the upper bridge may extend vertically beyond the upper wall thereby forming a shoulder at the connection of the upper wall and the upper bridge. Preferably, the shoulder may be formed in transverse and vertical plane i.e. a plane in which the transverse and vertical axis of the trihedron lie. The shoulder may be adapted to cooperate with a front end of the yoke, more specifically front end of the top wall of the yoke, to restrict longitudinally forward movement of the yoke with respect to the spacer member, when the spacer member is secured to the yoke.

In a non-limiting embodiment of the present invention, the spacer member may further include a projection extending in longitudinally forward direction from the front end. The projection may have a predefined curvature. The projection may be adapted to be received through a corresponding receiving space provided in the base member for securing the spacer member to the base member. The curvature of the projection may be adapted to cooperate with a bead formed in the base member to guide the spacer member while mounting it on the base member and to restrict vertical movement of the spacer member, more specifically the front end of the spacer member, with respect to the base member.

In a non-limiting embodiment of the present invention, at least one of the flanks may include a notch formed at a predefined location at a lower edge of the flank. Preferably, the notch may be provided on both the flanks of the spacer member. The notch may extend vertically upwards from lower edge of the flank and may be adapted to cooperate with a corresponding rib provided on the base member. The cooperation of the notch with the rib of the base member may ensure relative positioning between the spacer member and the base member.

In a non-limiting embodiment of the present invention, at least one of the flanks may include a leg formed at a predefined location, the leg extending vertically downwards. Preferably, the leg may be provided on both the flanks of the spacer member. The leg may extend downwards to such a height that lower edge of the leg may be positioned vertically above a pin formed on inner surface of corresponding side wall of the yoke, when the spacer member is secured to the yoke. This may restrict the movement of the yoke away from the spacer member, along vertical axis of the trihedron. The leg may be further adapted such that at least a portion of the leg may be received in a corresponding channel provided in the base member to limit longitudinal play between the spacer member and the base member.

In a non-limiting embodiment of the present invention, the spacer member may further include a ramp provided at the rear end. The ramp may connect the two flanks and may extend vertically upwards. The ramp may extend in a vertically upward direction to a predefined height from the plane of the upper wall of the spacer member and may be adapted to cooperate with the top wall of the yoke when the spacer member is secured to the yoke, to properly align the longitudinal orientation of the spacer member with respect to the yoke.

The present invention also relates to an adapter assembly for a wiper system. The adapter assembly may include a base member and a spacer member. The base member may have a front end and a rear end longitudinally opposite to the front end. In other words the base member may extend between the front end and the rear end. The spacer member may have two flanks spaced apart from each other and connected to each other by an upper wall. The flanks may extend along longitudinal axis and the upper wall may be integrally formed with the flanks. The spacer member may be releasably mounted on the base member. The spacer member may include two longitudinal lugs distributed laterally on either sides of a central longitudinal axis of the spacer member. Each of the two longitudinal lugs may be extended by side arms emerging from an upper bridge. The upper bridge may be formed at longitudinally front end of the upper wall of the spacer member such that the upper wall of the spacer member extends longitudinally rearwards from the upper bridge. The longitudinal lugs may be adapted to be received in corresponding slots provided on side walls of a yoke of a wiper arm. The longitudinal lugs may guide the spacer member while mounting the spacer member to the yoke. The longitudinal lugs may further restrict relative vertical movement between the spacer member of the adapter assembly and the yoke, once the yoke is attached to the adapter assembly. The spacer member may further include a flexible cantilever extending towards the rear end from the upper wall. The flexible cantilever may include a button formed at an end opposite to the upper wall. The button may be vertically offset from the upper wall of the spacer member. When the yoke is attached to the adapter assembly, the button of the flexible cantilever may be received in a corresponding cut-out formed in a top wall of the yoke. The button may ensure proper positioning of the spacer member and thereby of the adapter assembly relative to the yoke. In some cases, the button may also lock the spacer member and thereby the adapter assembly to the yoke. Advantageously, the button may also facilitate detachment of the yoke along with the spacer member from the base member of the adapter assembly. The spacer member may further include a bearing tab connecting the flanks and having an upper surface vertically offset from the upper wall. The bearing tab may be positioned substantially below the button. Preferably, the bearing tab may be integrally formed with the flanks of the spacer member and may extend vertically upwards from upper edges of the flanks. The bearing tab may cooperate with a corresponding feature such as a push-button of the base member to secure the base member to the spacer member.

In a non-limiting embodiment of the present invention, the base member may include a pair of longitudinal walls extending along a longitudinal axis. The longitudinal walls may be spaced apart from each other and connected to each other by an upper wall. Preferably, the upper wall of the base member may connect upper edges of the longitudinal walls and may be integrally formed with the longitudinal walls.

In a non-limiting embodiment of the present invention, the base member may further include a head formed at the front end of the base member. The head may be connected to the longitudinal walls and the upper wall of the base member. The head may extend beyond a longitudinal and transverse plane in which the upper wall extends, and beyond a longitudinal and vertical plane in which the longitudinal walls extend. The head may cooperate with the front end of the spacer member to define an end-stop for the spacer member, thus preventing longitudinal translational movement of the spacer member with respect to the base member.

In a non-limiting embodiment of the present invention, the base member may further include a receiving space continuously formed in the upper wall of the base member and the head of the base member. More specifically, the upper wall of the base member may include a first opening formed in the vicinity of the head and may continue to form a recess in the head, and the first opening along with the recess may define the receiving space.

In a non-limiting embodiment of the present invention, the spacer member may further include a projection extending in longitudinally forward direction from the front end of the spacer member. The projection may have a predefined curvature to cooperate with a bead formed in the head of the base member to guide the spacer member while mounting the spacer member on the base member and to restrict vertical movement of the spacer member, more specifically, the front end of the spacer member, with respect to the base member.

In a non-limiting embodiment of the present invention, the base member may further include a channel formed at a predefined location on at least one of the longitudinal walls. The channel may receive at least a portion of a leg formed at a predefined location on corresponding flank of the spacer member. Preferably, the channel may be formed on both the longitudinal walls and may cooperate with legs provided on corresponding flanks of the spacer member. This cooperation between the legs of the spacer member and the channels of the base member may limit longitudinal play between the spacer member and the base member.

In a non-limiting embodiment of the present invention, the spacer member may further include a notch formed at a lower edge of at least one of the flanks. The notch may receive at least a portion of a rib formed on the corresponding longitudinal wall of the base member. Preferably, the notch may be formed on both the flanks of the spacer member and may cooperate with ribs provided on corresponding longitudinal walls of the base member. The cooperation of the notches of the spacer member with the ribs of the base member may ensure relative positioning between the spacer member and the base member.

In a non-limiting embodiment of the present invention, the base member may further comprise a deformable member including a flexible stem extending longitudinally rearwards from a fixed end connected to the longitudinal walls. The deformable member may further include a push-button formed at an end of the flexible stem opposite to the fixed end. The push-button may be adapted to be locked on the bearing tab of the spacer member to secure the base member to the spacer member. Further, at least a portion of the push-button of the base member may be positioned below the button of the spacer member such that the button of the spacer member may be pressed to cooperate with the push-button for unlocking the base member from the spacer member.

In a non-limiting embodiment of the present invention, the push-button may include a lip portion extending longitudinally forward. The lip portion may be positioned vertically between the button of the spacer member and the bearing tab of the spacer member. The lip portion of the push-button of the base member may cooperate with the bearing tab of the spacer member to releasably secure the base member to the spacer member. Further, when the button of the spacer member is pushed downwards, the button presses against the lip portion of the push-button and unlocks the push-button from the bearing tab of the spacer member.

The present invention also relates to a wiper system for a motor vehicle. The wiper system may include a connector attached to a wiper blade, an adapter assembly pivotally connected to the connector, and a wiper arm releasably connected and secured to the adapter assembly. The wiper arm may include a yoke having a top wall connecting two side walls. The top wall of the yoke may include a cut-out. The adapter assembly may include a spacer member having two flanks spaced apart from each other and connected to each other by an upper wall. The spacer member may further include two longitudinal lugs distributed laterally on either sides of a central longitudinal axis of the spacer member. Each of the two longitudinal lugs may be extended by side arms emerging from an upper bridge. The longitudinal lugs may be received in corresponding slots provided on side walls of the yoke. The longitudinal lugs may guide the spacer member while mounting the spacer member to the yoke. The longitudinal lugs may further restrict relative vertical movement between the spacer member and the yoke. The spacer member may further include a flexible cantilever extending longitudinally towards the rear end from the upper wall. The flexible cantilever may include a button formed at an end opposite to the upper wall. The button may be vertically offset from the upper wall of the spacer member. The button of the flexible cantilever may be received in the cut-out of the yoke. The button may ensure proper positioning of the spacer member relative to the yoke. In some cases, the button may also lock the spacer member to the yoke. Advantageously, the button may also facilitate detachment of the spacer member along with the yoke from a base member of the adapter assembly. The spacer member may further include a bearing tab connecting the upper edges of the flanks and having an upper surface vertically offset from the upper wall. The bearing tab may be positioned below the button of the spacer member. Preferably, the bearing tab may be integrally formed with the flanks and may extend vertically upwards from upper edges of the flanks. The bearing tab may cooperate with a push-button of the base member to secure the base member to the spacer member that is attached to the yoke.

In a non-limiting embodiment of the present invention, the spacer member may further include a projection extending in longitudinally forward direction from the front end of the spacer member. The projection of the spacer member may be received through a receiving space provided in the base member to secure at least a front end of the spacer member to the base member. The projection may have a predefined curvature to cooperate with a bead formed in a head of the base member to guide the spacer member while mounting the spacer member along with the yoke on the base member and to restrict vertical movement of the spacer member, more specifically, the front end of the spacer member, with respect to the base member.

In a non-limiting embodiment of the present invention, the yoke may include pins formed on each of the side walls of the yoke. More specifically, the pin may be formed on inner surfaces of the side walls of the yoke and may extend inwards. The pin may be positioned in a channel provided on the base member and vertically below a leg formed on corresponding flank of the spacer member. More specifically, the pin provided on the side wall may be received in the channel formed on corresponding longitudinal wall of the base member. Further, the leg formed on corresponding flank of the spacer member may also be received in the channel such that the pin of the yoke is positioned vertically below the leg of the spacer member. This may facilitate desired relative positioning and securing of the yoke, the spacer member, and the base member.

### BRIEF DESCRIPTION OF DRAWINGS

The present invention is expounded in detail below with the aid of the presented drawings. Items shown in the drawings are not to scale and are simplified to increase clarity of disclosure. In the drawings:

FIG. 1 illustrates a schematic perspective view of a wiper system, according to an embodiment of present invention;

FIG. 2A illustrates a schematic perspective view of a connection of a wiper arm with a connector of wiper blade, according to an embodiment of present invention;

FIG. 2B illustrates an exploded view of the wiper system, according to an embodiment of present invention;

FIGS. 3A and 3B illustrate a schematic perspective view and front view of a wiper arm respectively, according to an embodiment of present invention;

FIG. 4 illustrates an exploded view of an adapter assembly, according to an embodiment of present invention;

FIG. 5A illustrates a schematic perspective view of a spacer member of the adapter assembly, according to an embodiment of present invention;

FIG. 5B illustrates a schematic side view of the spacer member, according to an embodiment of present invention;

FIG. 6A illustrates a schematic perspective view of a base member of the adapter assembly, according to an embodiment of present invention;

FIG. 6B illustrates a schematic side view of the base member, according to an embodiment of present invention;

FIG. 6C illustrates a schematic perspective view from bottom side of the base member, according to an embodiment of present invention;

FIGS. 7, 8, 9 and 10 illustrate the assembly steps for connecting the wiper arm to the adapter assembly, according to an embodiment of present invention;

FIG. 8A illustrates a schematic side view of the spacer member attached to the wiper arm, according to an embodiment of present invention;

FIG. 8B illustrates a sectional view taken along line B-B in FIG. 8, according to an embodiment of present invention;

FIG. 9A illustrates a sectional view of FIG. 9 taken along central longitudinal axis, according to an embodiment of present invention;

FIG. 10A illustrates a schematic top view of FIG. 10, according to an embodiment of present invention;

FIG. 10B illustrates a sectional view taken along line C-C in FIG. 10A, according to an embodiment of present invention;

FIG. 10C illustrates zoomed view of the zone ‘Z’ in FIG. 10B, according to an embodiment of present invention; and

FIG. 10D illustrates a sectional view taken along line D-D in FIG. 10A, according to an embodiment of present invention.

### DETAILED DESCRIPTION OF THE INVENTION

The characteristics, variants and different modes of realization of the invention may be associated with each other in various combinations, in so far as they are not incompatible or exclusive with each other. In particular, variants of the invention comprising only a selection of features subsequently described in from the other features described may be imagined, if this selection of features is enough to confer a technical advantage and/or to differentiate the invention from prior art.

The following embodiments are examples. Although the description refers to one or more embodiments, this does not necessarily mean that each reference is to the same embodiment, or that the features apply only to one embodiment. Simple features of different embodiments may also be combined and/or interchanged to provide further embodiments.

In the present description, certain elements or parameters may be indexed, for example first element or second element as well as first parameter and second parameter or first criterion and second criterion, etc. In this case, it is a simple indexing operation to differentiate and name elements or parameters or criteria which are close, but not identical. In this case, simple indexing is used to differentiate and name elements or parameters or criteria which are close, but not identical. This indexing does not imply that one element, parameter or criterion has priority over another, and such names can easily be interchanged without going beyond the scope of this description. Nor does this indexing imply an order in time, for example to assess a particular criterion.

In the following detailed description, the terms ‘longitudinal’, ‘transverse’ and ‘vertical’ refer to the orientation of the wiper system according to the invention with reference to a trihedron L, V, T. Within this frame of reference, a longitudinal direction corresponds to a main direction of elongation of the respective component or in case of assembly such as wiper system, adapter assembly, spacer member attached to the yoke of the wiper arm etc., the longitudinal direction corresponds to a main direction of elongation of the a wiper blade of this wiper system, this longitudinal direction being parallel to a longitudinal axis L of the trihedron L, V, T, illustrated in the figures. A vertical direction corresponds to a stacking direction of a connector, an adapter assembly and a wiper arm of the wiper system, this vertical direction being parallel to a vertical axis V of the trihedron L, V, T, and this vertical axis V being perpendicular to the longitudinal axis L. Finally, a transverse direction corresponds to a direction parallel to a transverse axis T of the trihedron L, V, T, this transverse axis T being perpendicular to the longitudinal axis L and the vertical axis V. The terminologies ‘longitudinally’, ‘transversely’, and ‘vertically’ may be understood with reference to the longitudinal axis L, transverse axis T, and the vertical axis V, respectively.

In addition, the designations ‘lower’ and ‘upper’ with respect to the elements of the wiper system are understood with respect to the distance of these elements from the wiper blade, a lower end/side of such elements corresponding to the end/side disposed in the vicinity of this wiper blade, while an upper end/side corresponds to the end/side disposed at a distance from the wiper blade. Similarly the terms ‘upwards’, ‘above’, ‘downwards’, and ‘below’ may be interpreted with respect to the vertical axis V of trihedron. The designations ‘front’, ‘forward’, ‘rear’ and ‘rearward’ needs to be understood with reference to the longitudinal direction L of the trihedron. Further, the designation ‘height’ refers to the dimension of the component/element measured along the vertical axis L. Moreover the designations ‘inner’ and ‘outer’ are understood with respect to the longitudinal central axis of the component. For example, the surface disposed towards the longitudinal central axis of the component may be referred as “inner surface” and the surface disposed away from the longitudinal central axis of the component may be referred as “outer surface”. Moreover the terminologies ‘inwards’, and ‘outwards’ may be understood, accordingly.

The present invention relates to an adapter assembly for a wiper system used to clean a glazed surface of a vehicle, for example a windscreen, so as to improve driver's visibility of the road in front of the vehicle. The wiper system generally comprises at least one wiper arm carrying at one end, a wiper blade which extends mainly along the longitudinal axis L. The wiper blade comprises at least one wiper strip (rubber), intended to be in contact with the glazed surface to be cleaned, and a structure for supporting the said wiper strip. The wiper blade is secured to the wiper arm by an adapter assembly. The adapter assembly according to the present invention includes a spacer member to make the adapter assembly compatible with wiper arms of different types/designs. The adapter assembly further includes a base member adapted to be pivotally mounted on a connector that is fixed to the structure of the wiper blade. The spacer member may be releasably attached to a yoke of the wiper arm and the spacer member along with the yoke of the wiper arm may be mounted on the base member to make the connection between the wiper arm and the wiper blade. The adapter assembly may be compatible with a wiper arm having inverted U-shaped yoke with a cut-out provided in a top wall of the yoke. Particularly, the spacer member includes two longitudinal lugs distributed laterally on either sides of a central longitudinal axis of the spacer member. These longitudinal lugs may be adapted to be received in corresponding slots provided in side walls of the yoke. The spacer member may further include a flexible cantilever having a button adapted to be received in the cut-out of the yoke. The spacer member may further include legs adapted to cooperate with pins provided on side walls of the yoke, for preventing separation of the spacer member from the yoke in vertical direction. The legs may also be received in corresponding channels provided in the base member for limiting longitudinal play between the spacer member and the base member. Moreover, the spacer member may include a projection adapted to be received in a corresponding receiving space provided in the base member to secure the spacer member with the base member. Thus, the spacer member may be secured to the yoke first and then the spacer member may be mounted to the base member thereby securing the yoke to the adapter assembly.

FIG. 1 illustrates a schematic perspective view of a wiper system 100, according to an embodiment of the present invention. The wiper system 100 may include at least one wiper arm 200, one end of which may be connected to an output shaft of a wiper motor (not shown) through suitable linkages. At least one wiper blade 500 may be connected to another end of the wiper arm 200. As shown, an adapter assembly 300 may be used as a connection means between the wiper arm 200 and the wiper blade 500. The adapter assembly 300, more particularly, allows the wiper blade 500 to be connected to a yoke 220 of the wiper arm 200. Further, the wiper blade 500 may include at least one wiper strip (rubber) intended to be in contact with the surface of the windshield to be cleaned.

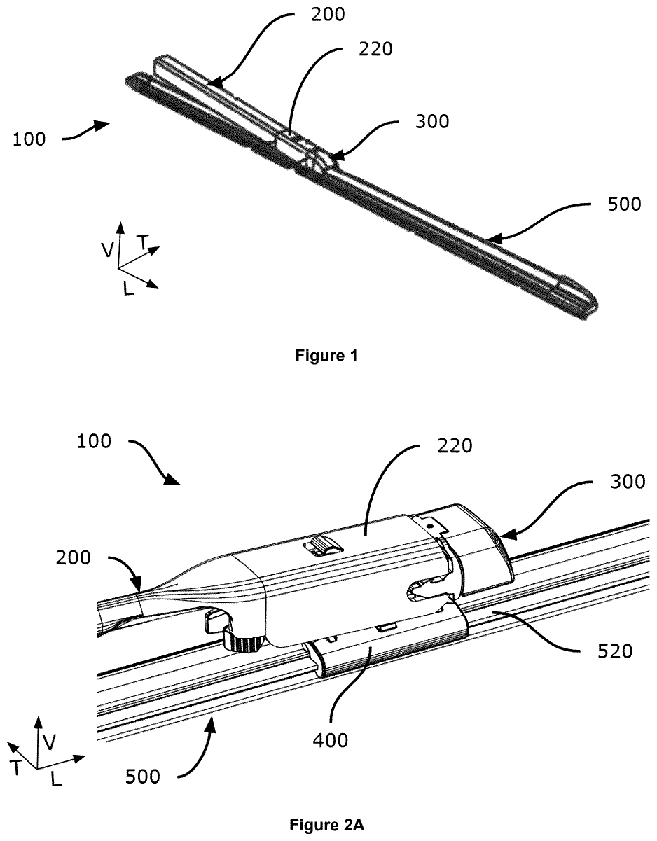

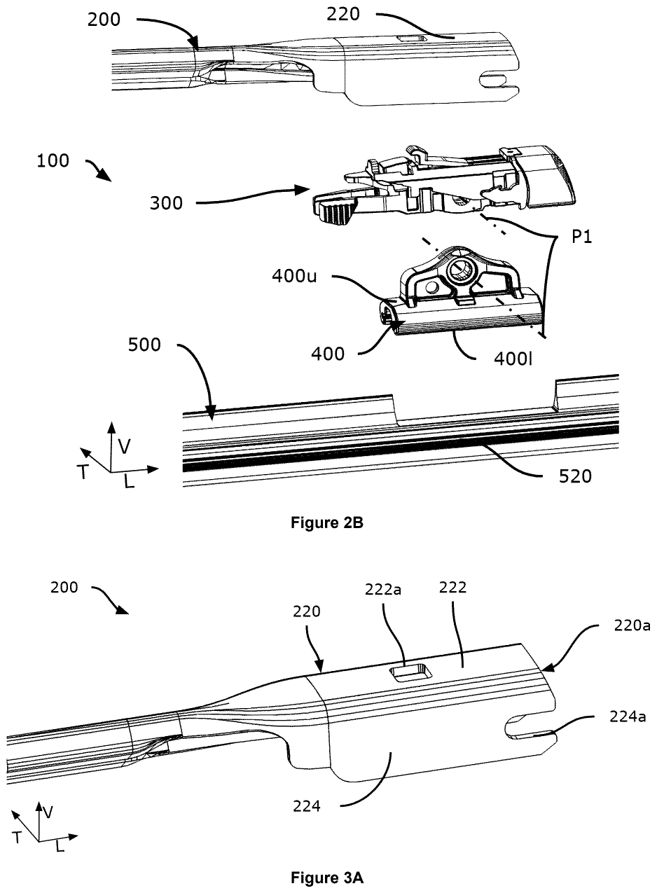

FIG. 2A illustrates the wiper system 100 according to an exemplary embodiment of the present invention. The wiper arm 200 may be connected to a connector 400 of the wiper blade 500 through the adapter assembly 300. It is to be understood that the connector 400 may be a single component or may be an assembly of two or more components, as per the design requirements. The yoke 220 of the wiper arm 200 may be adapted to be releasably attached to the adapter assembly 300, from upper side of the adapter assembly 300. The connector 400 may be fixedly connected to a structure 520 of the wiper blade 500. As shown in exploded view in FIG. 2B, the connector 400 may include an upper side 400u and a lower side 400l opposite to the upper side 400u, along the vertical axis V of the trihedron. In particular, the lower side 4001 of the connector 400 may be designed to carry the structure 520 of the wiper blade 500. The adapter assembly 300 may be located on the upper side 400u of the connector 400. The connector 400 may be fixedly or releasably attached to the structure 520 of the wiper blade 500. The adapter assembly 300 may be pivotally connected to the connector 400 about a pivot axis P1, thereby allowing the wiper blade 500 to pivot at one of the ends of the wiper arm 200 to ensure that the wiper blade 500 is pressed against the glass surface to be wiped.

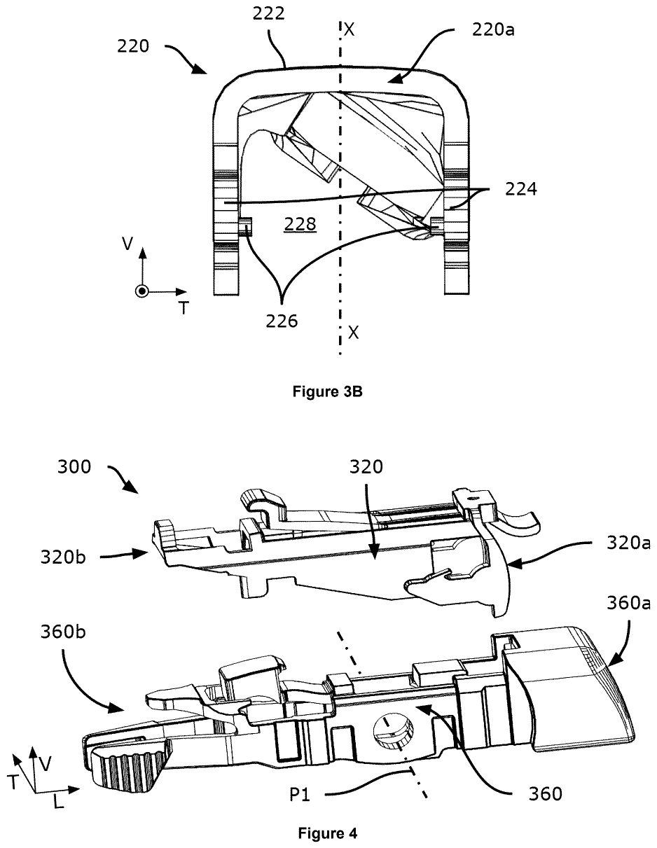

FIGS. 3A and 3B show the wiper arm 200, particularly, the end of the wiper arm 200 having the yoke 220 formed therein. The yoke 220 may generally be inverted U-shaped, with a top wall 222 connecting two side walls 224 extending along the longitudinal axis L of the trihedron. The side walls 224 and the top wall 222 may define a receiving zone 228, shown in FIG. 3B, suitable for receiving the adapter assembly 300, more specifically, a spacer member of the adapter assembly 300. The yoke 220 may include a front end 220a which may be open so that the yoke 220 may be attached to the adapter assembly 300. The yoke 220 may further include a cut-out 222a formed at a predefined location on the top wall 222. Preferably, the cut-out 222a may be provided at such a location relative to the front end 220a that a button of a flexible cantilever of the spacer member may be received in the cut-out 222a to position and secure the spacer member of the adapter assembly 300 with the yoke 220. The cut-out 222a may have any predefined polygonal or curved or any other suitable shape. Each of the side walls 224 may include a slot 224a extending longitudinally rearwards from the front end 220a of the yoke 220, to a predefined distance. It is to be noted that only one slot 224a is visible in FIG. 3A that is formed on the visible side wall 224, however, another side wall 224 that is hidden behind the visible side wall 224 may have a similar slot 224a. The slot 224a may be formed as an oblong cut-out open at the front end 220a of the yoke 220. The side walls 224 may further include a pin 226 extending transversally towards central axis X-X of the yoke 220, from inner surface of each of the side walls 224, as shown in FIG. 3B. The pins 226 may be provided at such a location on the side walls 224 that they cooperate with corresponding legs provided in a spacer member and corresponding channels formed in a base member of the adapter assembly 300.

FIG. 4 illustrates an exploded view of the adapter assembly 300, according to an embodiment of the present invention. The adapter assembly 300 may include a base member 360 and a spacer member 320 suitable for being mounted on each other along a vertical stacking direction, i.e., a direction parallel to the vertical axis V of the trihedron. The base member 360 may extend in a direction parallel to the longitudinal axis L of the trihedron, and may include a front end 360a and a rear end 360b arranged on either sides of the pivot axis P1. The base member 360 may be adapted to be pivotally mounted on the connector 400 (refer FIG. 2B) about the pivot axis P1. The spacer member 320 may extend in a direction parallel to the longitudinal axis L of the trihedron, and may include a front end 320a and a rear end 320b longitudinally opposite to the front end 320a. The spacer member 320 may cooperate with the base member 360 from upper side of the base member 360 to define the adapter assembly 300. The base member 360 and the spacer member 320 may be arranged such that the front end 360a of the base member 360 and the front end 320a of the spacer member 320 are positioned on same side of the pivot axis P1, along the longitudinal axis L of the trihedron.

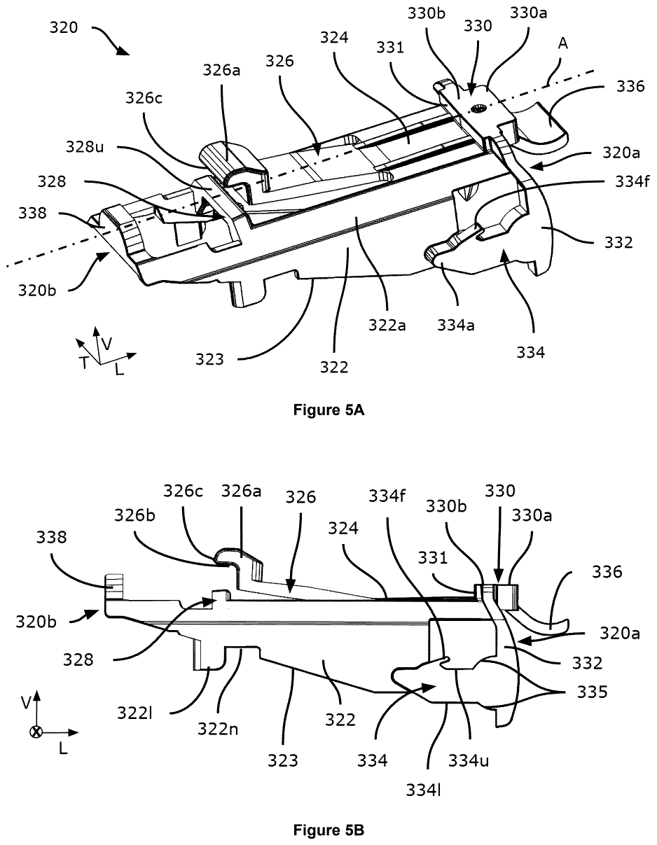

FIGS. 5A and 5B illustrate the spacer member 320 of the adapter assembly 300. The spacer member 320 may include flanks 322 extending along the longitudinal axis L of the trihedron. The flanks 322 may be spaced apart from each other, and may be connected to each other by an upper wall 324. Preferably, the upper wall 324 may be integrally formed with the flanks 322, and the upper wall 324 may extend between upper edges of the flanks 322. Preferably, a tapered portion 322a may be formed at the upper edges of the flanks 322 for properly mounting the spacer member 320 to the base member 360.

The spacer member 320 may further include at least one longitudinal lug 334 suitable for being received in the slot 224a of one of the side walls 224 of the yoke 220 of the wiper arm 200. The longitudinal lug 334 may have a predefined height along vertical axis V of the trihedron and a predefined thickness along transverse axis T of the trihedron. The longitudinal lug 334 may have a narrow rear end 334a, as clearly seen in FIG. 5B. In other words, the height of the longitudinal lug 334 near the rear end 334a decreases in longitudinally rearward direction. Moreover, the longitudinal lug 334 may be laterally offset from the flank 322 such that an inner surface of the longitudinal lug 334 near the rear end 334a, may be fixedly secured to the outer surface of the flank 322. Preferably, the longitudinal lug 334 may be integrally formed with the flank 322. The longitudinal lug 334 may be vertically spaced from the upper wall 324 such that the longitudinal lug 334 is properly received in the slot 224a of the yoke 220 when the spacer member 320 is attached to the yoke 220. According to the example illustrated in FIGS. 5A and 5B, the spacer member 320 may include two longitudinal lugs 334 distributed laterally on either sides of a central longitudinal axis A of the spacer member 320. It is to be understood that the central longitudinal axis A may be defined as an axis parallel to the longitudinal axis L of the trihedron and which is equidistant from the flanks 322 or from the lateral extremities of the spacer member 320. These two longitudinal lugs 334 may be extended in each case by a side arm 332, these two side arms 332 being connected to each other by an upper bridge 330 from which the upper wall 324 emerges and extends longitudinally rearwards. In other words, the two side arms 332 may extend vertically downwards from the upper bridge 330, as shown in FIG. 5A. The two side arms 332 and the upper bridge 330 may form an inverted U-shape, seen in a vertical and transverse plane. More particularly, the upper bridge 330 forms a base of this U-shape, from which each of the side arms 332 extend vertically downwards, thus forming the branches of this U-shape.

Each longitudinal lug 334 may lie mainly in a vertical and longitudinal plane, i.e., a plane in which the longitudinal axis L and the vertical axis V of the trihedron lie. Moreover, at least a part of the each side arm 332 extends in a plane coinciding with the main plane of extent of the longitudinal lug 334 that it extends. Each longitudinal lug 334 may extend in a main direction substantially perpendicular to a main direction of extent of the side arms 332 that extends it. More specifically, the longitudinal lug 334 may mainly extend along the longitudinal axis L of the trihedron, whereas the side arms 332 may extend along the vertical axis V of the trihedron.

The longitudinal lug 334 may include a deformable finger 334f formed at an upper edge 334u of the longitudinal lug 334, as shown in FIG. 5B. Alternatively, the deformable finger 334f may be provided on a lower edge 3341 of the longitudinal lug 334. Alternatively, the deformable finger 334f may be provided on both the upper edge 334u and the lower edge 3341 of the longitudinal lug 334. The deformable finger 334f may project in a direction inclined at a predefined angle with the longitudinal axis L. The deformable finger 334f may be adapted such that when the longitudinal lug 334 is received in the slot 224a provided on the side wall 224 of the yoke 220, the deformable finger 334f may deform to cooperate with inner edge of the slot 224a to grip the yoke 220. The longitudinal lug 334 may further include a curved portion 335 at the connection of the longitudinal lug 334 with the side arm 332. The curved portion 335 may be bulged out from the upper edge 334u and/or the lower edge 2241 of the longitudinal lug 334, as shown in FIG. 5B.

The upper wall 324 of the spacer member 320 may substantially lie in a longitudinal and transverse plane, i.e., a main plane of extent of the upper wall 324 is a plane in which the longitudinal axis L and transverse axis T of the trihedron lie. As clearly seen in FIG. 5B, upper surface of the upper bridge 330 and upper surface of the upper wall 324 may have a vertical offset from each other. In other words, the upper bridge 330 may extend beyond the upper wall 324 along the vertical axis V of the trihedron, thus forming a shoulder 331. Advantageously, this vertical offset may allow the formed shoulder 331 to abut the front end 220a of the yoke 220 of the wiper arm 200 to limit longitudinally forward movement of the yoke 220 with respect to the spacer member 320. The upper bridge 330 may further include at least one narrowed front portion 330a. In other words, this narrowed front portion 330a has a transverse dimension, i.e., a dimension measured parallel to the transverse axis T of the trihedron, between two opposite edges of this front narrowed portion 330a, that is smaller than a transverse dimension—measured according to the same constraints—of a rear portion 330b of the upper bridge 330, as can be clearly seen in FIG. 5A. As further explained below, the narrowed front portion 330a of the upper bridge 330 may be suitable for being received in corresponding receiving space provided in the base member 360. In other words, the narrowed front portion 330a may be suitable for abutting against a head of the base member 360.

The spacer member 320 may further include a projection 336 emerging from the upper bridge 330 and extending in longitudinally forward direction. Preferably, the projection 336 may emerge from the narrowed front portion 330a of the upper bridge 330. The projection 336 may have a predefined curvature, as can be clearly seen in FIG. 5B. The projection 336 may be adapted to be received in corresponding receiving space provided in the base member 360 while mounting the spacer member 320 on the base member 360, and may cooperate with the head of the base member 360 to vertically lock the spacer member 320, more specifically the front end 320a of the spacer member 320 with respect to the base member 360. Moreover, the curvature of the projection 336 may form a guide for mounting the base member 360 to the spacer member 320.

As shown in FIGS. 5A and 5B, the upper wall 324 may extend between the upper bridge 330 that connects the side arms 332, and a flexible cantilever 326. The flexible cantilever 326 may extend rearwards from the upper wall 324 and may be inclined upwards with respect to the longitudinal axis L of the trihedron. The flexible cantilever 326 may further include a button 326a formed at free end i.e. an end of the flexible cantilever 326 opposite to the upper wall 324. Thus, the button 326a may be raised from a plane of the upper wall 324, in vertically upward direction. As further detailed below, this button 326a may be adapted to be received in the cut-out 222a provided in the top wall 222 of the yoke 220 of the wiper arm 200. The button 326a may include at least one indentation 326b, preferably formed from rear edge 326c of the button 326a, as clearly seen in FIG. 5B. The indentation 326b may preferably be formed on lower side of the button 326a.

The spacer member 320 may further include a bearing tab 328 connecting the upper edges of the flanks 322. The bearing tab 328 may have a top surface 328u being vertically offset from the plane of the upper wall 324. Preferably, the bearing tab 328 may be positioned below the button 326a such that when the button 326a is pressed downwards, the bearing tab 328 may cooperate with the indentation 326b of the button 326a.

As can be seen in FIG. 5B, the flanks 322 may have an inclined lower edge 323 for at least a portion of the flank 322 towards rear end 320b of the spacer member 320 such that the height of the flank 322 measured from the plane of the upper wall 324 may reduce towards longitudinally rear end 320b. The flanks 322 may further include a notch 322n formed extending upwards from the lower edge 323 and positioned substantially below the flexible cantilever 326. The notch 322n may be provided at such a location on the flank 322 that the notch 322n cooperates with a corresponding rib provided on a corresponding longitudinal wall of the base member 360, when the spacer member 320 is mounted on the base member 360. It is to be understood that the notch 322n may have any curved and/or tapered and/or slant portions that enhances the cooperation of the notch 322n of the spacer member 320 with the rib of the base member 360. Further, the shape of the notch 322n of the spacer member 320 may complement the shape of the corresponding rib of the base member 360. Advantageously, the notch 322n of the spacer member 320 may cooperate with the rib of the base member 360 to ensure proper positioning of the spacer member 320 with respect to the base member 360 and vice versa. Additionally, the cooperation between the notch 322n of the spacer member 320 and the rib of the base member 360 may also limit longitudinal play between the spacer member 320 and the base member 360. The flank 322 may further include a leg 322l formed near the notch 322n, preferably towards longitudinally rear side of the notch 322n. The leg 322l may extend vertically downwards to a predefined distance measured from the plane of upper wall 324. The height of the leg 322l i.e. the distance of lower edge of the leg 322l from the plane of the upper wall 324 may be predetermined such that the pin 226 provided on the side wall 224 of the yoke 220 may be positioned below the leg 322l when the spacer member 320 is secured to the yoke 220. In other words, when the spacer member 320 is attached to the yoke 220 of the wiper arm 200, the leg 322l of the spacer member 320 is positioned above the pin 226 of the yoke 220 to prevent the movement of the yoke 220 relative to the spacer member 320 in vertically upward direction. The leg 322l may be further adapted to cooperate with corresponding channel provided in longitudinal walls of the base member 360. It is to be understood that the leg 322l may have any curved and/or tapered and/or slant portions that enhances the cooperation of the leg 322l of the spacer member 320 with the channel of the base member 360. It is to be noted that the leg 322l of the spacer member and the pin 226 of the yoke 220 may be received in the channel of the base member 360 when the yoke 220 is secured to the adapter assembly 300.

The spacer member 320 may further include a ramp 338 formed at rear end 320b. The ramp 338 may connect to the flanks 322, more particularly the ramp 338 may be formed between rear ends of the flanks 322. The ramp 338 may extend in a vertically upward direction to a predefined height from the plane of the upper wall 324. The ramp 338 may be adapted to cooperate with the top wall 222, more specifically with inner surface of the top wall 222 of the yoke 220, when the spacer member 320 is secured to the yoke 220, to properly align the longitudinal orientation of the spacer member 320 with respect to the yoke 220, more specifically with respect to the top wall 222 of the yoke 220 of the wiper arm 200. The ramp 338 may have any predefined shape and dimension such that the yoke 220 may be longitudinally inclined with respect to the spacer member 320 of the adapter assembly 300 to achieve desired orientation of the yoke 220 with the spacer member 320 of the adapter assembly 300.

It is to be noted that front ends of the side arms 332 and the front end of the narrowed front portion 330a of the upper bridge 330 may form the front end 320a of the spacer member 320 and the ramp 338 may form rear end 320b of the spacer member 320. The projection 336 may extend from the front end 320a of the spacer member 320 in longitudinally forward direction.

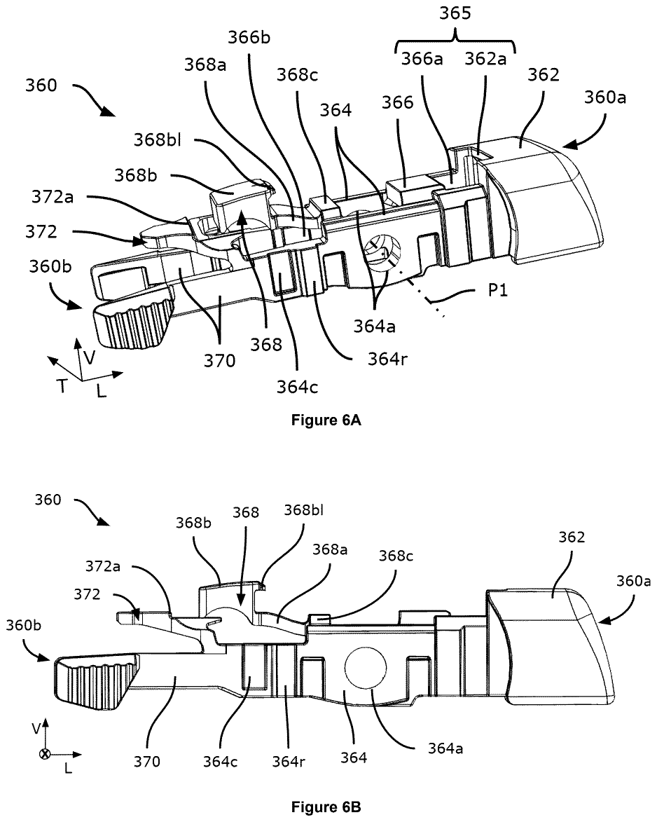

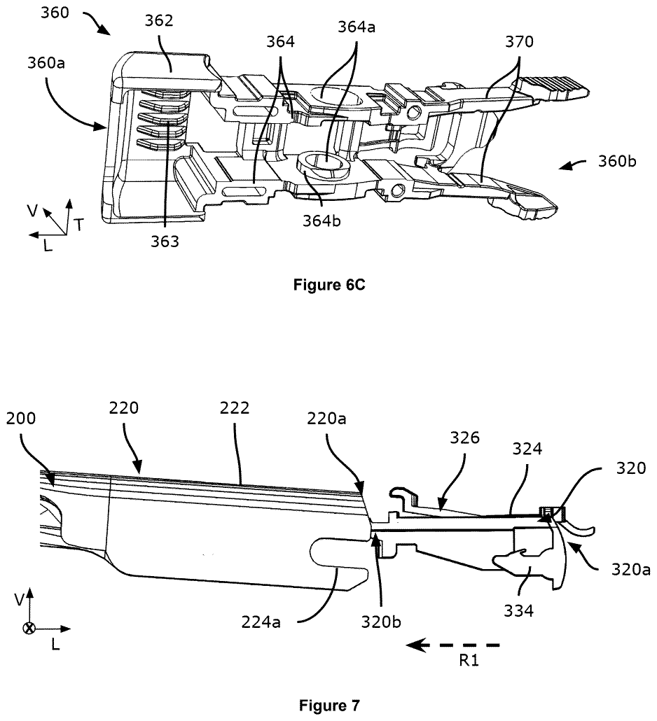

FIGS. 6A, 6B and 6C illustrate the base member 360 of the adapter assembly 300, according to an embodiment of the present invention. The base member 360 may include a pair of longitudinal walls 364 extending along the longitudinal axis L of the trihedron. The longitudinal walls 364 may be substantially mutually parallel and spaced apart from each other transversely i.e. along the transverse axis T of the trihedron. The longitudinal walls 364 may be connected to each other by an upper wall 366 substantially perpendicular to the longitudinal walls 364. The longitudinal walls 364 along with the upper wall 366 may define the body of the base member 360. The longitudinal walls 364 and the upper wall 366 may define a space to accommodate the connector 400. The base member 360 may further include a head 362 formed at the front end 360a. Each of the longitudinal walls 364 may be connected to the head 362 and may extend longitudinally rearwards from the head 362. The head 362 may have the vertical and transverse dimensions greater than the body of the base member 360. In other words, the head 362 may extend beyond a longitudinal and transverse plane in which the upper wall 366 extends, and beyond a longitudinal and vertical plane in which the longitudinal walls 364 extend. When the spacer member 320 is mounted on the base member 360, the head 362 may cooperate with the front end 320a of the spacer member 320 to define an end-stop for the spacer member 320, thus preventing translational movement of the spacer member 320 with respect to the base member 360, in longitudinally forward direction.

The base member 360 may include two flexible tongues 370 extending rearwards from the longitudinal walls 364 along the longitudinal axis L of the trihedron. The flexible tongues 370 may be integrally formed with the longitudinal walls 364 of the base member 360. The flexible tongues 370 may be brought closer to each other by elastic deformation. The flexible tongues 370 may be substantially symmetrical about a plane of symmetry extending in longitudinal and vertical directions and situated equidistantly from the longitudinal walls 364.

As shown in FIGS. 6A and 6B, the base member 360 may further include a channel 364c formed in the longitudinal wall 364 near the flexible tongue 370, preferably, towards longitudinally forward side of the flexible tongue 370. The channel 364c may have a rectangular shape oriented along vertical axis V of the trihedron such that the channel 364c may be open at the top i.e. at the upper edge of the longitudinal wall 364 to receive the leg 322l of the spacer member 320 while mounting the base member 360 to the spacer member 320. The base member 360 may further include a rib 364r provided towards longitudinally forward side of the channel 364c. The rib 364r may protrude transversely outwards from the longitudinal wall 364 such that at least a portion of the rib 364r, preferably, an upper portion of the rib 364r may be received in the notch 322n provided on the flank 322 of the spacer member 320. Advantageously, the rib 364r of the base member 360 may cooperate with the notch 322n of the spacer member 320 to ensure proper positioning and mounting of the base member 360 with the spacer member 320. Additionally, the cooperation between the notch 322n of the spacer member 320 and the rib 364r of the base member 360 may also limit longitudinal play between the spacer member 320 and the base member 360. It is to be noted that the rib 364r of the base member 360 and the notch 322n of the spacer member 320 may have curves and/or tapered portions complementing with each other to achieve proper cooperation between them.

As shown in FIG. 6A, the upper wall 366 may include a first opening 366a and a second opening 366b which are aligned in the longitudinal direction i.e. along the longitudinal axis L of the trihedron, and open onto the internal space formed by the longitudinal walls 364 and the upper wall 366. The first opening 366a may be formed in the vicinity of the head 362 and may continue to form a recess 362a in the head 362. The first opening 366a along with the recess 362a may define a receiving space 365 for insertion of the projection 336 of the spacer member 320. The second opening 366b may be provided in the vicinity of the flexible tongues 370 and may be partially covered by a deformable member 368. The deformable member 368 may include a flexible stem 368a and a push-button 368b. The flexible stem 368a may extend mainly in the longitudinally rearward direction and may have a fixed end 368c some distance from the flexible tongues 370, which may be connected to the longitudinal walls 364 by a bridge of material. The push-button 368b may be formed at an end of the flexible stem 368a opposite to the fixed end 368c. The deformable member 368, especially the flexible stem 368a may elastically deform vertically to bring the push-button 368b closer to the longitudinal walls 364. Moreover, the push-button 368b may include a lip portion 368bl formed at the front side of the push-button 368b and extending longitudinally forward, as clearly shown in FIG. 6B. The lip portion 3681 may be formed such that the lip portion 368bl may be positioned between the indentation 326b of the button 326a and the top surface 328u of the bearing tab 328 of the spacer member 320, when the base member 360 is attached to the spacer member 320. The lip portion 368bl of the base member 360 may cooperate with the bearing tab 328 of the spacer member 320 to releasably secure the base member 360 to the spacer member 320.

As shown in FIGS. 6A and 6B, each of the longitudinal walls 364 may include an orifice 364a. At least one of the orifices 364a may be substantially circular i.e. having circular cross-section. Both the orifices 364a may have same or different shapes and/or dimensions. The orifices 364a may together define the pivot axis P1 of the base member 360 relative to the connector 400. One of the orifices 364a may have a ring 364b projecting from the corresponding longitudinal wall 364 and extending towards the other longitudinal wall 364, as shown in FIG. 6C. The ring 364b may contribute to the assembling of the base member 360 with the connector 400 by this ring 364b being elastically clip-fastened to complementing means of the connector 400. The orifices 364a and the ring 364b may form a pivoting means for pivoting the base member 360 relative to the connector 400.

As shown in FIG. 6C, the base member 360 may further include a bead 363 provided under/inside the head 362, that is to say the bead 363 may extend from the head 362 of the base member 360, in the direction of the wiper blade 500 when the adapter assembly 300 is mounted in the wiper system 100 for which it is intended. According to an exemplary embodiment, the head 362 may cooperate with the projection 336 provided on the front end 320a of the spacer member 320. It is understood that the projection 336 of the spacer member 320 may be inserted into the head 362 of the base member 360 through the receiving space 365 formed by the first opening 366a and the recess 362a, and then the projection 336 may be slid under the aforementioned bead 363. The cooperation between the projection 336 of the spacer member 320 and the bead 363 of the head 362 of the base member 360 may ensure the vertical locking of the spacer member 320 with respect to the base member 360, that is to say the locking along the vertical axis V of the trihedron. According to an alternative variant, the projection 336 of the spacer member may be engaged under the head 362 of the base member 360 which would be devoid of such a bead 363.

The base member 360 may further include a raised tab 372 formed towards longitudinally rear side of the deformable member 368 such that the raised tab 372 may be connected to the longitudinal walls 364 of the base member 360 by bridging material, as shown in FIGS. 6A and 6B. The raised tab 372 may be vertically offset from the plane of the upper wall 366 of the base member 360. Further, there may be provided enough longitudinal gap between the raised tab 372 and the push-button 368b to allow free movement of the push-button 368b when the flexible stem 368a is deformed. The raised tab 372 may include a step 372a which may be adapted to cooperate with rear end 320b of the spacer member 320 to ensure proper mounting of the spacer member 320 on the base member 360. Advantageously, the cooperation between the raised tab 372 and the rear end 320b of the spacer member 320 may limit longitudinal play between the spacer member 320 and the base member 360.

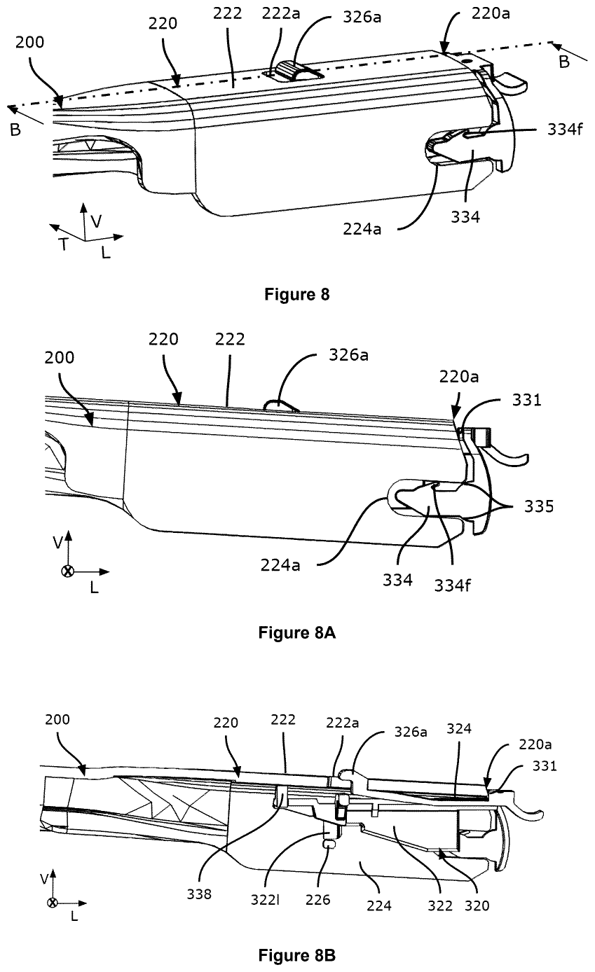

FIGS. 7, 8, 9 and 10 show steps for attaching the wiper arm 200 to the wiper blade 500. As shown in FIG. 7, first the spacer member 320 may be aligned longitudinally with the yoke 220 of the wiper arm 200 such that the open front end 220a of the yoke 220 faces towards the rear end 320b of the spacer member 320. It is to be noted that the top wall 222 of the yoke 220 may be inclined with respect to the upper wall 324 of the spacer member 320, along the longitudinal axis L of the trihedron. Once the spacer member 320 is properly aligned with the yoke 220 of the wiper arm 200, the spacer member 320 may be moved along the longitudinal axis L towards the yoke 220, as shown by arrow R1 in FIG. 7, such that the spacer member 320 may be received in the receiving zone 228 defined by the side walls 224 and the top wall 222 of the yoke 220 (refer FIG. 3B). The spacer member 320 may be moved further in the receiving zone 228 longitudinally rearwards till the spacer member 320 is properly attached to the yoke 220, as shown in FIG. 8. It is to be noted that during longitudinally rearward movement of the spacer member 320 in the receiving zone 228 of the yoke 220, the flexible cantilever 326 may be deformed towards the plane of the upper wall 324 of the spacer member 320. Further, the longitudinal lugs 334 of the spacer member 320 may be received in the slots 224a of the yoke 220. It is to be also noted that the narrow rear end 334a of the may act as a guide during insertion of the longitudinal lug 334 in the slot 224a. Alternatively, the spacer member 320 may be moved inside the receiving zone 228 of the yoke 220 without deforming the flexible cantilever 326, in which case the pins 226 of the yoke cooperates with the legs 322l of the spacer member 320 and pushes the legs 322l inwards to allow the further longitudinal movement of the spacer member 320. It is to be further understood that in addition to the longitudinal movement, the spacer member 320 may be required to be moved vertically upwards to achieve desired cooperation between the spacer member 320 and the yoke 220.

FIGS. 8 and 8A show the spacer member 320 securely attached to the yoke 220 of the wiper arm 200. To achieve this stage, the spacer member 320 may be moved longitudinally rearwards in the receiving zone 228 of the yoke 220 till the button 326a of the flexible cantilever 326 is received in the cut-out 222a provided in the top wall 222 of the yoke 220. The button 326a may cooperate with the cut-out 222a to lock the spacer member 320 to the yoke 220. Advantageously, the cooperation between the button 326a of the spacer member 320 and the cut-out 222a of the yoke 220 may also ensure proper positioning of the spacer member 320 in the receiving zone 228 of the yoke 220. However, it is to be noted that the button 326a may just be received in the cut-out 222a and may not lock the spacer member 320 to the yoke 220, without affecting the assembly of the spacer member 320 with the yoke 220. Further, the open front end 220a of the yoke 220 may abut against the shoulder 331 of the spacer member 320, as clearly seen in the sectional view in FIG. 8B. Further, as shown in FIG. 8A, the longitudinal lugs 334 of the spacer member 320 may be received in the slots 224a of the yoke 220 such that the deformable finger 334f may be biased against the inner edge of the slot 224a thereby firmly gripping the yoke 220. Further, the side walls 222 of the yoke 220, more specifically the front ends of the side walls 222 at the slots 224a may cooperate with the curved portion 335 of the longitudinal lugs 334 to further improve the engagement of the spacer member 320 with the yoke 220. As shown in sectional view in FIG. 8B, the leg 322l formed in the flank 322 of the spacer member 320 may rest on the pin 226 provided on the side wall 224 of the yoke 220 from upper side of the pins 226. The legs 322l of the spacer member 320 may cooperate with the pins 226 of the yoke 220 to restrict vertically upward movement of the yoke 220 with respect to the spacer member 320. Advantageously, the cooperation between the longitudinal lugs 334 and the slots 224a, and the cooperation between the legs 322l and the pins 226 may together restrict the relative movement between the yoke 220 and the spacer member 320 along the vertical axis V of the trihedron. Moreover, the ramp 338 provided at rear end 320b of the spacer member 320 may cooperate with the inner surface of the top wall 222 of the yoke 220 such that the desired angular orientation, along the longitudinal axis L, of the yoke 220 with respect to the upper wall 324 of the spacer member 320 may be achieved, as shown in FIG. 8B. Furthermore, the side walls 224 of the yoke 220 may be juxtaposed to the flanks 322 of the spacer member 320 from transversely outer sides, thereby preventing relative movement between the yoke 220 and the spacer member 320 along transverse axis T of the trihedron. Thus, the spacer member 320 may be firmly secured to the yoke 220 of the wiper arm 200 as shown in FIGS. 8, 8A and 8B.

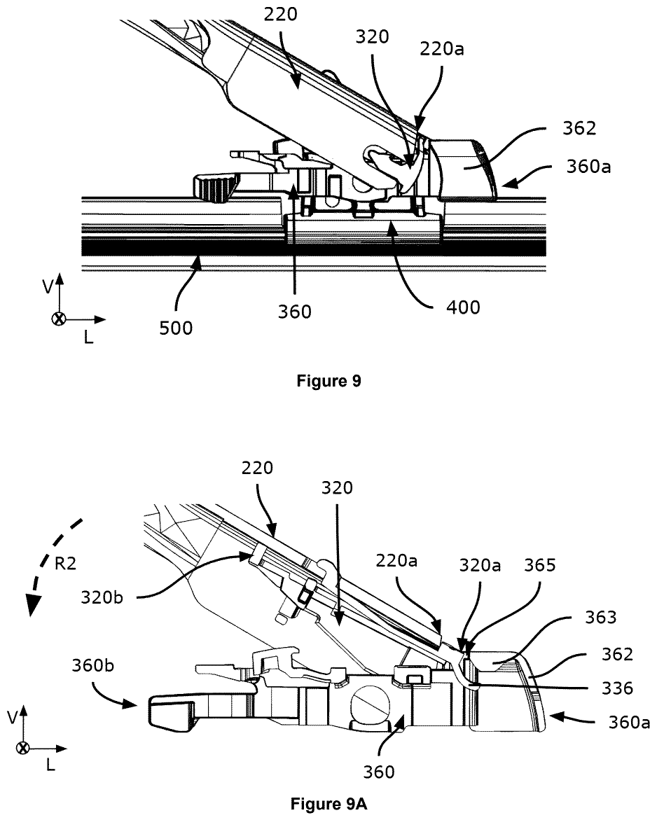

As shown in FIG. 9, the base member 360 may be pivotally mounted on the connector 400 of the wiper blade 500 about the pivot axis P1. The yoke 220 along with the spacer member 320 may be tilted about the transverse axis T such that the front end 320a of the spacer member 320 is in the vicinity of the head 362 of the base member 360 and the rear end 320b of the spacer member 320 is vertically raised away from the base member 360, as can be seen in sectional view in FIG. 9A. The projection 336 of the spacer member 320 may be received in the head 362 of the base member 360 through the receiving space 365 of the base member 360 such that the projection 336 may be positioned vertically below the bead 363 formed in the head 362 of the base member 360, as shown in sectional view in FIG. 9A. Once the projection 336 of the spacer member 320 is inserted in the head 362 through the receiving space 365 of the base member 360, the yoke 220 along with the spacer member 320 may be rotated about the transverse axis T such that the rear end 320b of the spacer member 320 is moved towards the base member 360 as shown by arrow R2 in FIG. 9A. Alternatively, the base member 360 may be rotated about the transverse axis T such that the rear end 360b of the base member 360 is moved towards the spacer member 320 in a reverse direction of the arrow R2 shown in FIG. 9A. It is to be noted that the wiper blade 500 and the connector 400 are not shown in FIG. 9A for ease of understanding.

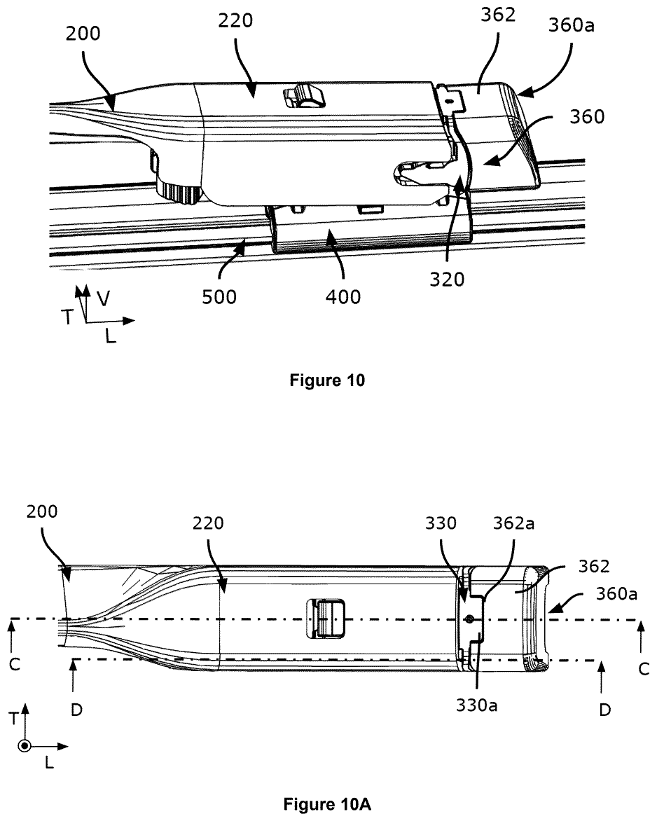

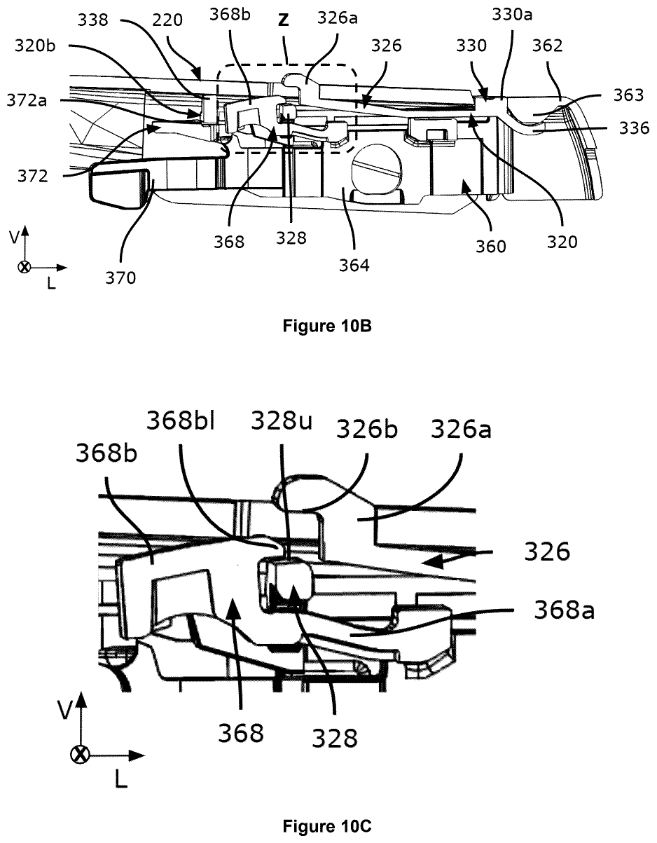

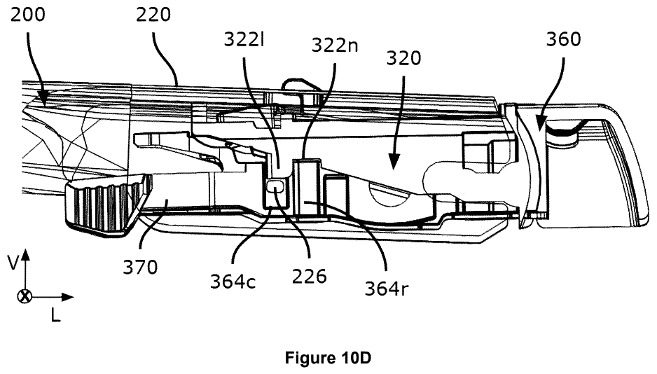

FIG. 10 shows the yoke 220 along with the spacer member 320 assembled to the base member 360. As shown in top view in FIG. 10A, the upper bridge 330 of the spacer member 320 may cooperate with the head 362 of the base member 360. More preferably, the narrowed front portion 330a of the upper bridge 330 may be received in the recess 362a of the head 362 of the base member 360. Thus, the cooperation between the narrowed front portion 330a of the spacer member 320 and the head 362 of the base member 360 may restrict forward movement along the longitudinal axis L and lateral movements along the transverse axis T of the spacer member 320 along with the yoke 220 with respect to the base member 360. Further, as shown in sectional view in FIG. 10B, the projection 336 of the spacer member 320 may be positioned below the bead 363 of the base member 360 to lock the spacer member 320, more specifically, the front end 320a of the spacer member 320 with respect to the base member 360. It is to be noted that the shape of the bead 363 may compliment with the curvature of the projection 336 to achieve desired cooperation between them.

Further, as shown in FIG. 10B, the raised tab 372 of the base member 360 may cooperate with the rear end 320b of the spacer member 320, more specifically, at least a portion of the rear end 320b of the spacer member 320 may be received in the step 372a of the raised tab 372 to ensure proper positioning between the spacer member 320 and the base member 360. Advantageously, the cooperation between the raised tab 372 and the rear end 320b of the spacer member 320 may limit longitudinal play between the spacer member 320 and the base member 360.

It is to be further noted that, as shown in FIG. 10B, the ramp 338 provided at rear end 320b of the spacer member 320 may cooperate with the inner surface of the top wall 222 of the yoke 220 such that the desired angular orientation, along the longitudinal axis L, of the yoke 220 with respect to the upper wall 324 of the spacer member 320 may be achieved. Advantageously, the ramp 338 of the spacer member 320 may ensure that there is enough space between the plane of the upper wall 324 of the spacer member 320 and the top wall 222 of the yoke 220 to accommodate at least a portion of the push-button 368b of the base member 360 therein, such that the push-button 368b remains locked to the bearing tab 328 of the spacer member 320. Moreover, the longitudinal distance between the ramp 338 and the bearing tab 328 may be defined such that at least a portion of the push-button 368b may be positioned between them and the push-button 368b may be able to move from locked state to unlocked state and vice versa, without any interference.

When the rear end 320b of the spacer member 320 is moved towards the base member 360 as shown by arrow R2 in FIG. 9A, the deformable member 368 of the base member 360 may deform and then cooperate with the bearing tab 328 of the spacer member 320 to releasably secure the base member 360 with the spacer member 320. More specifically, the lip portion 368bl of the push-button 368 may be positioned above the bearing tab 328 and may lock the base member 360 to the spacer member 320 by cooperating with the top surface 328u of the bearing tab 328, as shown in FIG. 10C. It is to be noted that the lip portion 368bl of the push-button 368 may be positioned between the indentation 326b of the button 326a and the bearing tab 328 of the spacer member 320, along vertical axis V of trihedron.

FIG. 10D shows section view of the assembly taken with a cutting plane coinciding with inner surface of one of the side walls 224 of the yoke 220. It is to be noted that while moving rear end 320b of the spacer member 320 towards the rear end 360b of the base member 360, the flexible tongues 370 of the base member 360 may be deformed towards each other thereby receiving the flexible tongues 370 in the receiving zone 228 of the yoke 220. It is to be further noted that the base member 360 may be devoid of the flexible tongues 370, without functionally affecting the assembly of the yoke 220 with the adapter assembly 300. Moreover, the leg 322l of the spacer member 320 and the pin 226 of the yoke 220 may be positioned in the channel 364c formed on the longitudinal wall 364 of the base member 360. Further, at least the upper portion of the rib 364r of the base member 360 may be received in the notch 322n of the spacer member 320. Thus the yoke 220 along with the spacer member 320 may be properly secured to the base member 360. Advantageously, the rib 364r of the base member 360 may cooperate with the notch 322n of the spacer member 320 to ensure proper positioning and mounting of the base member 360 with the spacer member 320. Additionally, the cooperation between the notch 322n of the spacer member 320 and the rib 364r of the base member 360 may also limit longitudinal play between the spacer member 320 and the base member 360.

While releasing the yoke 220 of the wiper arm 200 from the adapter assembly 300, with reference to FIG. 10C, the button 326a of the spacer member 320 may be pressed towards the bearing tab 328 thereby contacting the lip portion 368bl of the push-button 368b of the base member 360 to disengage the push-button 368b from the bearing tab 328. Then the rear end 320b of the spacer member 320 may be raised upwardly away from the rear end 360b of the base member 360 and the projection 336 of the spacer member 320 may be removed out of the receiving space 365 of the base member 360. Alternatively, once the push-button 368b of the base member 360 is disengaged from the bearing tab 328 of the spacer member 320, the rear end 360b of the base member 360 may be moved away from the spacer member 320. Thus the yoke 220 along with the spacer member 320 may be detached from the base member 360. To release the spacer member 320 from the yoke 220, with reference to FIGS. 8, 8A and 8B, the button 326a of the spacer member 320 may be pushed to disengage the button 326a from the cut-out 222a of the yoke 220. Once the button 326a is out of the cut-out 222a, the spacer member 320 may be moved along the longitudinal axis L in forward direction thereby disengaging the longitudinal lugs 334 of the spacer member 320 from the slots 224a of the yoke 220 and the spacer member 320 may be pulled out of the receiving zone 228 of the yoke 220 thereby detaching the spacer member 320 from the yoke 220.

It is to be noted that the wiper blade 500 and the connector 400 are not shown in FIGS. 10A, 10B and 10D for ease of understanding.

The invention shall not, however, be limited to the means and configurations described and illustrated herein, and shall also extend to any equivalent means or configuration described and illustrated herein, and to any technical combination operating such means.

### LIST OF REFERENCE SIGNS

| | |
|---|---|
| 100 | Wiper system |
| 200 | Wiper arm |
| 220 | Yoke |
| 220a | Front end of the Yoke |
| 222 | Top wall of the Yoke |
| 222a | Cut-out |
| 224 | Side wall of Yoke |
| 224a | Slot |
| 226 | Pin |
| 228 | Receiving zone |
| 300 | Adapter assembly |
| 320 | Spacer member |
| 320a | Front end of spacer member |
| 320b | Rear end of spacer member |
| 322 | Flank |
| 322a | Tapered portion |
| 322n | Notch |
| 322l | Leg |
| 323 | Lower edge of the flank |
| 324 | Upper wall |
| 326 | Flexible cantilever |
| 326a | Button |
| 326b | Indentation |
| 328 | Bearing tab |
| 328u | Top surface of the bearing tab |
| 330 | Upper bridge |
| 330a | Narrowed front portion of the upper bridge |
| 330b | Rear portion of the upper bridge |
| 331 | Shoulder |
| 332 | Side arm |
| 334 | Longitudinal lug |
| 334a | Rear end of the longitudinal lug |
| 334u | Upper edge of the longitudinal lug |
| 334l | Lower edge of the longitudinal lug |
| 334f | Deformable finger |
| 335 | Curved portions |
| 336 | Projection |
| 338 | Ramp |
| 360 | Base member |
| 360a | Front end of base member |
| 360b | Rear end of base member |
| 362 | Head |
| 362a | Recess |
| 363 | Bead |
| 364 | Longitudinal wall |
| 364a | Orifice |
| 364b | Ring |
| 364c | Channel |
| 364r | Rib |
| 365 | Receiving space |
| 366 | Upper wall |
| 366a | First opening |
| 366b | Second opening |
| 368 | Deformable member |
| 368a | Flexible stem |
| 368b | Push-button |
| 368bl | Lip portion |
| 368c | Fixed end of the flexible stem |
| 370 | Flexible tongue |
| 372 | Raised tab |
| 372a | Step |
| 400 | Connector |
| 400u | Upper side of the connector |
| 400l | Lower side of the connector |
| 500 | Wiper blade |
| 520 | Structure |

1. A spacer member for an adapter assembly of a wiper system, the spacer member comprising:
a front end and a rear end longitudinally opposite to the front end;
two flanks extending longitudinally between the front end and the rear end, the flanks being spaced apart from each other and connected to each other by an upper wall, the upper wall extending longitudinally rearwards from an upper bridge;
two longitudinal lugs distributed laterally on either sides of a central longitudinal axis of the spacer member, each of the two longitudinal lugs being extended by side arms emerging from the upper bridge;
a flexible cantilever extending towards the rear end from the upper wall, the flexible cantilever including a button formed at an end opposite to the upper wall, the button being vertically offset from the upper wall; and
a bearing tab connecting the flanks and having an upper surface vertically offset from the upper wall, the bearing tab being positioned substantially below the button.

2. The spacer member according to claim 1, wherein the flexible cantilever further includes at least one indentation formed on lower side of the button, the indentation being configured to cooperate with the bearing tab.

3. The spacer member according to claim 1, wherein at least one of the longitudinal lugs includes a deformable finger projecting from at least one of an upper edge and a lower edge of the longitudinal lug.

4. The spacer member according to claim 1, wherein the upper bridge extends vertically beyond the upper wall thereby forming a shoulder at the connection of the upper wall and the upper bridge.

5. The spacer member according to claim 1, further comprising a projection extending in longitudinally forward direction from the front end, the projection having a predefined curvature.

6. The spacer member according to claim 1, wherein at least one of the flanks include a notch formed at a predefined location at a lower edge of the flank.

7. The spacer member according to claim 1, wherein at least one of the flanks include a leg formed at a predefined location, the leg extending vertically downwards.

8. The spacer member according to claim 1, further comprising a ramp provided at the rear end, the ramp connecting the two flanks and extending vertically upwards.

9. An adapter assembly for a wiper system, the adapter assembly comprising:
a base member having a front end and a rear end longitudinally opposite to the front end; and
a spacer member having two flanks spaced apart from each other and connected to each other by an upper wall, the spacer member being releasably mounted on the base member,
wherein the spacer member includes two longitudinal lugs distributed laterally on either sides of a central longitudinal axis of the spacer member, each of the two longitudinal lugs being extended by side arms emerging from an upper bridge,
wherein the spacer member further includes a flexible cantilever extending towards the rear end from the upper wall, the flexible cantilever including a button formed at an end opposite to the upper wall, the button being vertically offset from the upper wall, and
wherein the spacer member further includes a bearing tab connecting the flanks and having an upper surface vertically offset from the upper wall, the bearing tab being positioned substantially below the button.

10. The adapter assembly according to claim 9, wherein the base member includes a pair of longitudinal walls extending along a longitudinal axis, the longitudinal walls being spaced apart from each other and connected to each other by an upper wall.

11. The adapter assembly according to claim 10, wherein the base member further includes a head formed at the front end of the base member, the head being connected to the longitudinal walls and the upper wall of the base member.

12. The adapter assembly according to claim 11, wherein the base member further includes a receiving space continuously formed in the upper wall of the base member and the head of the base member.

13. The adapter assembly according to claim 12, wherein the spacer member further includes a projection extending in longitudinally forward direction from the front end of the spacer member, the projection being received in the head of the base member through the receiving space.

14. The adapter assembly according to claim 11, wherein the base member further includes a channel formed at a predefined location on at least one of the longitudinal walls, the channel receiving at least a portion of a leg formed at a predefined location on corresponding flank of the spacer member.

15. The adapter assembly according to claim 11, wherein the spacer member further includes a notch formed at a lower edge of at least one of the flanks, the notch receiving at least a portion of a rib formed on the corresponding longitudinal wall of the base member.

16. The adapter assembly according to claim 11, wherein the base member further comprises a deformable member including a flexible stem extending longitudinally rearwards from a fixed end connected to the longitudinal walls, the deformable member further including a push-button formed at an end of the flexible stem opposite to the fixed end.

17. The adapter assembly according to claim 16, wherein the push-button includes a lip portion extending longitudinally forward, the lip portion being positioned vertically between the button of the spacer member and the bearing tab of the spacer member.

18. A wiper system for a motor vehicle, the wiper system comprising:
a connector attached to a wiper blade;
an adapter assembly pivotally connected to the connector; and
a wiper arm releasably connected and secured to the adapter assembly,
wherein the wiper arm includes a yoke having a top wall connecting two side walls, the top wall of the yoke including a cut-out,
wherein the adapter assembly includes a spacer member having two flanks spaced apart from each other and connected to each other by an upper wall,
wherein the spacer member includes two longitudinal lugs distributed laterally on either sides of a central longitudinal axis of the spacer member, each of the two longitudinal lugs being extended by side arms emerging from an upper bridge,
wherein the spacer member further includes a flexible cantilever extending longitudinally towards the rear end from the upper wall, the flexible cantilever including a button formed at an end opposite to the upper wall, the button being vertically offset from the upper wall, and
wherein the spacer member further includes a bearing tab connecting the upper edges of the flanks and having an upper surface vertically offset from the upper wall, the bearing tab being positioned below the button.

19. The wiper system according to claim 18, wherein the spacer member further includes a projection extending in longitudinally forward direction from the front end of the spacer member, the projection being received through a receiving space provided in the base member.

20. The wiper system according to claim 18, wherein the yoke includes pins formed on each of the side walls of the yoke, the pin being positioned in a channel provided on the base member and vertically below a leg formed on corresponding flank of the spacer member.
